(19) United States
(12) Patent Application Publication
(10) Pub. No.: US 2014/0114771 A1
(43) Pub. Date: Apr. 24, 2014

(54) APPARATUS AND METHOD FOR PROVIDING DIGITAL SIGNAGE SERVICE REFLECTING USER'S PREFERENCE

(71) Applicant: ELECTRONICS AND TELECOMMUNICATIONS RESEARCH INSTITUTE, Daejeon (KR)

(72) Inventors: Hwa-Suk KIM, Daejeon (KR); Dong-Hun LEE, Daejeon (KR); Hyun-Jin LEE, Daejeon (KR); Uk JANG, Daejeon (KR); Eun-Il KIM, Seoul (KR); Kee-Seong CHO, Daejeon (KR); Won RYU, Daejeon (KR)

(73) Assignee: ELECTRONICS AND TELECOMMUNICATIONS RESEARCH INSTITUTE, Daejeon (KR)

(21) Appl. No.: 14/058,043

(22) Filed: Oct. 18, 2013

(30) Foreign Application Priority Data
Oct. 19, 2012 (KR) 10-2012-0116936
Sep. 5, 2013 (KR) 10-2013-0106573

(51) Int. Cl. G06Q 30/02

(52) U.S. Cl. CPC G06Q 30/0269
USPC 705/14.66

(57) ABSTRACT

Provided is a method for providing a digital signage service reflecting a user's preference in a digital signage service providing server, the method including receiving user memo data from a mobile terminal through a specific digital signage terminal; generating a tailored content item corresponding to a shopping list contained in the user memo data; and outputting the generated tailored content item to the digital signage terminal.

### CROSS-REFERENCE TO RELATED APPLICATION

This application claims priority from Korean Patent Application Nos. 10-2012-0116936, filed on Oct. 19, 2012, and 10-2013-0106573, filed on Sep. 5, 2013 in the Korean Intellectual Property Office, the entire disclosures of which are incorporated herein by reference for all purposes.

### BACKGROUND

1. Field

The following description relates to digital signage technology, and more particularly, to an apparatus and method for providing a digital signage service reflecting preference of a user of a mobile terminal.

2. Description of the Related Art

Digital signage technology is used to digitally express an outdoor sign for an established advertisement through a digital image equipment. A device using a digital signage technology generally combines a display with an outdoor advertising equipment to provide text, image, or video content.

A conventional digital signage providing device is focused more on a service of digital signage itself than content transmission to a mobile device. Accordingly, the primary functions of the conventional digital signage providing device are installation, operation, and replacement of content.

However, with the development of communication networks, digital signage control has been recently performed remotely via a network. Interaction with a user also has been enhanced so as to provide a customized digital signage service suitable for an attribute of the user or circumstances.

In addition, in an effort to enhancing service effects, there has been an attempt to develop a digital signage system that provides tailored content according to gender or age of general users. Yet, such a statistical method based on general users is not good enough to provide a specific user with information suitable for characteristics about environment where the user is located, so that a significant advertising effect cannot be expected.

### SUMMARY

The following description relates to an apparatus and method for providing a digital signage service that is to provide a tailored content item reflecting a user's preference.

In addition, the following description relates to an apparatus and method for providing a is digital signage service that is to provide a tailored content item suitable for a location of a user.

In one general aspect, there is provided a method whereby a digital signage service providing server provides a digital signage service reflecting a user's preference, the method including receiving user memo data from a mobile terminal through a specific digital signage terminal; generating a tailored content item corresponding to a shopping list contained in the user memo data; and outputting the generated tailored content item to the digital signage terminal.

In yet another general aspect, there is provided a digital signage service providing server including a user memo data acquisition unit configured to receive user memo data from a mobile terminal through a specific digital signage terminal; a content generation unit configured to generate a tailored content item corresponding to a shopping list contained in the user memo data; and a tailored content item output control unit configured to output the generated tailored content item to the digital signage terminal.

In yet another general aspect, there is provided a mobile terminal including a user memo data input interface unit configured to receive user memo data containing a shopping list from a user and store the received user memo data; and a user memo data transfer unit configured to, in response to connection to a specific digital signage terminal, transfer the stored user memo data to the digital signage terminal.

In yet another general aspect, there is provided a method whereby a mobile terminal able to be connected to a digital signage terminal provides a digital signage service reflecting a user's preference; the method including receiving user memo data from a user; storing the received user memo data; and in response to connection to a digital signage terminal, transferring to the stored user memo data to the digital signage terminal.

Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a configuration of a digital signage providing system according to an exemplary embodiment of the present invention;

FIG. 2 is a diagram illustrating an inner configuration of a mobile terminal according to an exemplary embodiment of the present invention;

FIG. 3 is a user memory data according to an exemplary embodiment of the present invention;

FIG. 4 is a diagram illustrating a configuration of a digital signage service providing server according to an exemplary embodiment of the present invention;

FIG. 5 is a flow chart illustrating a method whereby a mobile terminal provides a digital signage service reflecting a user's preference according to an exemplary embodiment of the present invention;

FIG. 6 is a flow chart illustrating a method for providing digital signage service reflecting a user's preference according to an exemplary embodiment of the present invention; and

FIG. 7 is a flow chart illustrating a method for providing a digital signage service reflecting a user's preference according to another exemplary embodiment of the present invention.

Throughout the drawings and the detailed description, unless otherwise described, the is same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

Hereinafter, preferred embodiments of the present invention will be described in detail with reference to the accompanying drawings.

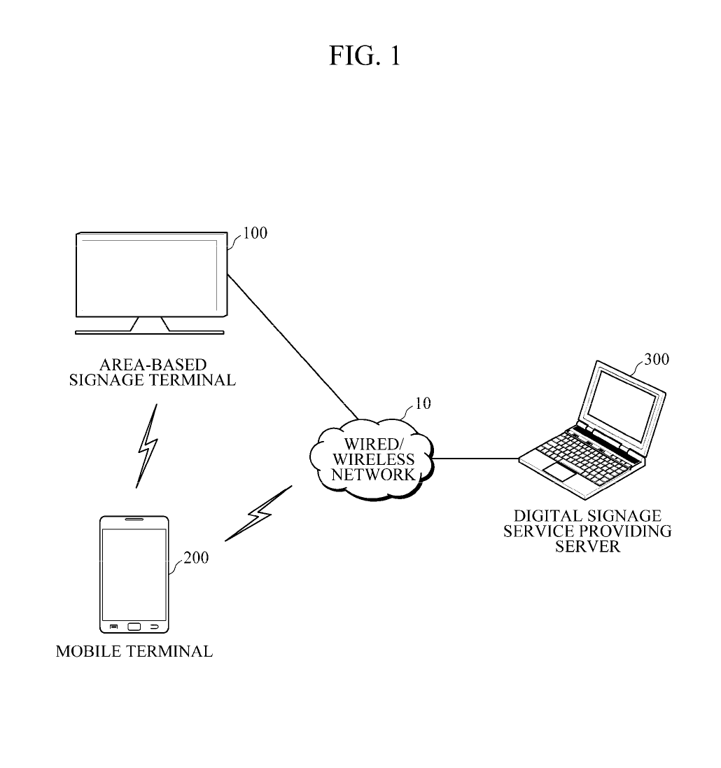

FIG. 1 is a diagram illustrating a configuration of a digital signage providing system according to an exemplary embodiment of the present invention.

Referring to FIG. 1, a digital signage providing system includes one or more digital signage terminals 100, a mobile terminal 200 and a digital signage service providing server (Hereinafter, referred to as ‘server’) 300.

A digital signage terminal 100 refers to a digital image apparatus that displays an image or information a flat display or a projector using digital technologies. In industries, the digital signage terminal 100 is used as a communication tool for marketing, advertising, training effects and consumer experience. In general, the digital signage terminal 100 provides not only broadcasts but also specific information in public places, such as airports, hotels and hospitals. The digital signage terminal 100 may output content containing advertisements received from the server 300 connected through the network 10 according to a predetermined schedule. Alternatively, the digital signage terminal 100 may output content according to interaction with a mobile terminal 200 of a user located at an area where the digital signage terminal is installed. The network 10 may include Wireless LAN (WLAN), Wi-Fi, Wireless Broadband (Wibro), World Interoperability for Microwave Access (Wimax), and High Speed Downlink Packet Access (HSDPA).

According to an exemplary embodiment of the present invention, the digital signage terminal 100 includes a communication interface (not shown) to associate the digital signage terminal 100 with the mobile terminal 200. The communication interface may include Near Field Communication (NFC), Bluetooth, and WLAN. Using the communication interface, user memo data stored in the mobile terminal 200 may be transferred to the server 300.

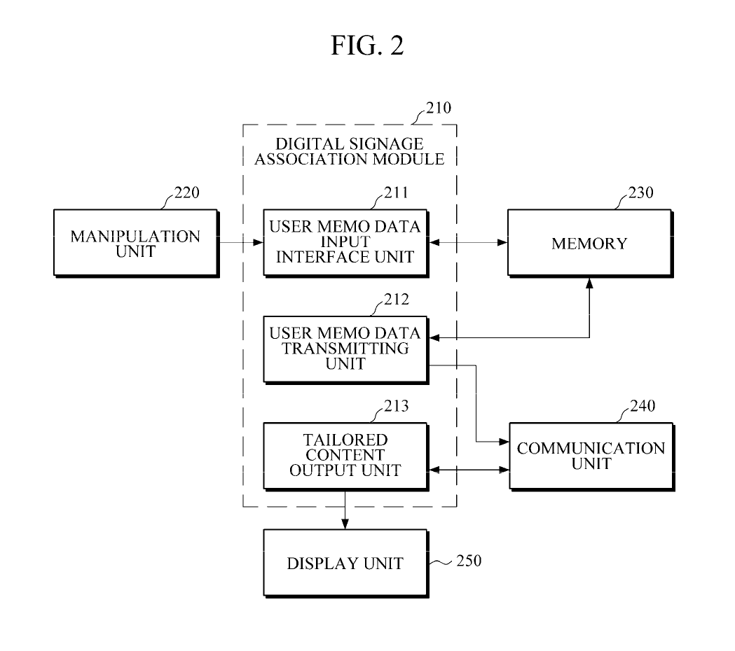

The mobile terminal 200 may be a computation capable terminal equipped with a memory and a microprocessor, including mobile phones, smart phones, notebook computers, digital broadcasting terminals, Personal Digital Assistants (PDAs), Portable Multimedia Players (PMPs), and navigation (for example, car navigation). According to an exemplary embodiment of the present invention, the mobile terminal 200 in association with the server 300 transfers a user's preference information to the server 300. The mobile terminal 200 will be described in detail with reference to FIG. 2.

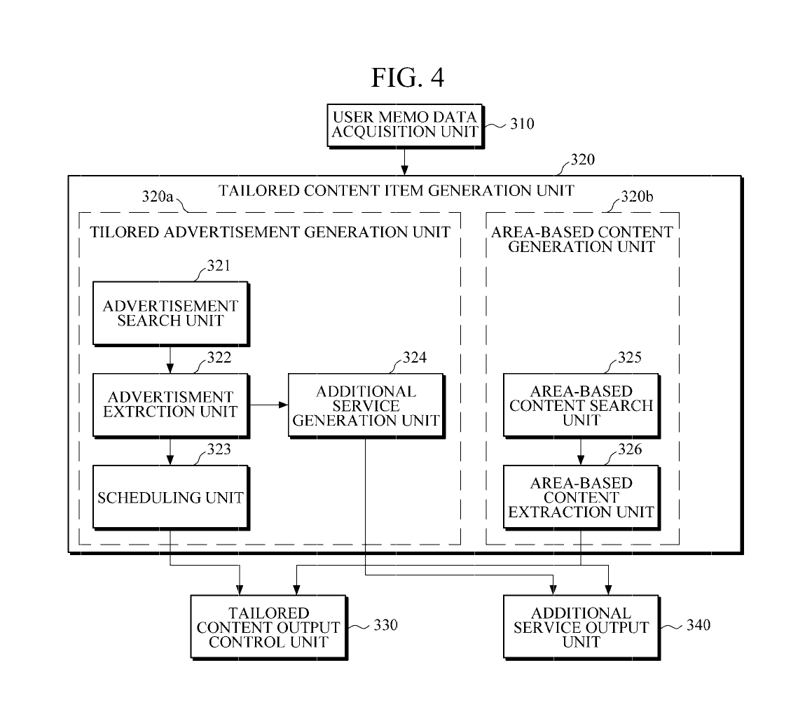

The server 300 provides one or more digital signage terminal 100 with one or more content items and reproduction schedule of each content item. According to an exemplary embodiment of the present invention, the server 300 receives user memo data indicating the user's preference, and provides a tailored content item to the digital signage terminal 100 according to the user's preference. The server 300 will be described in detail with reference to FIG. 4.

FIG. 2 is a diagram illustrating an interior configuration of a mobile terminal according is to an exemplary embodiment of the present invention.

Referring to FIG. 2, the mobile terminal 200 is equipped with a digital signage association module 210 that is downloaded in advance.

The digital signage association module 210 includes a user memo data input interface unit 211, a user memo data transferring unit 212, and a tailored content item outputting unit 213.

Using a manipulation unit 220 and a display unit 250 which are provided in the mobile terminal 200, the user memo data input interface unit 211 provides a user memo data input interface to receive user memo data containing a shopping list from a user. The user is able to add or delete the memo data at any time using the user memo data input interface unit 211. The user memo data is stored in the memory 230.

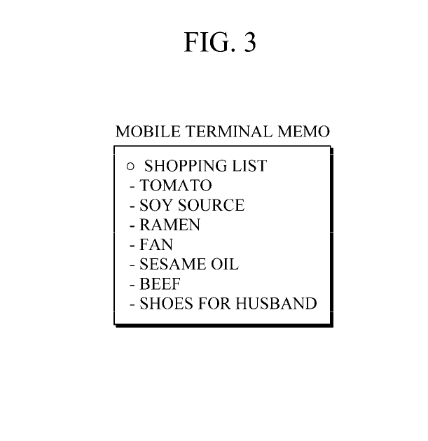

FIG. 3 is a diagram illustrating a user memo according to an exemplary embodiment of the present invention. Referring to FIG. 3, a user memo includes a shopping list.

When being connected to the digital signage terminal 200, the user memo data transferring unit 212 transfers the user memo data stored in the memory 230 to the digital signage terminal 100 through the server 300. In response to reception of an additional service from the server 300, the tailored content item outputting unit 213 outputs the additional service through the display unit 250. The additional service may include a coupon.

FIG. 4 is a diagram illustrating a configuration of a digital signage service providing server according to an exemplary embodiment of the present invention.

A server 300 includes a user memo data acquisition unit 310, a tailored content item generation unit 320 and an output unit 330. In addition, the server 300 further includes an additional service output unit 340.

The user memo data acquisition unit 310 receives user memo data from a user terminal 200 that is connected through a specific digital signage terminal 100. Hereinafter, a shopping is list will be used as an example of user memo data, but aspects of the present invention are not limited thereto. That is, the user memo data may include various kinds of a user's preference information including the user's interest.

The tailored content item generation unit 320 generates a tailored content item corresponding to the user memo data. In FIG. 4, the tailored content generation unit 320 may include a tailored advertisement generation unit 320a and an area-based content item generation unit 320b.

The tailored advertisement generation unit 320a includes an advertisement search unit 321, a tailored advertisement extraction unit 322, a scheduling unit 323 and an additional service generation unit 324.

If receiving user memo data including a shopping list of a specific mobile terminal from the user memo data acquisition unit 310, the advertisement search unit 321 searches for one or more advertising content items to be reproduced in a digital signage terminal 100 installed at an area where the mobile terminal is located.

The tailored advertisement extraction unit 322 extracts advertising content items about products belonging to product categories of the shopping list. Advertising content items extracted by the above-described method are shown in the following <Table 1>.

TABLE 1

| Content | Product | Category | | | |
|---|---|---|---|---|---|
| Item ID | Name | 1 | Category N | Location | Coupon |
| aaaa | xx soy source | soy source | grocery | url . . . | url . . . |
| aaab | yy ramen | ramen | | url . . . | |
| aaac | ABC shoes | shoes | men's | url . . . | url . . . |
| | | | shoes | | |

Table 1 shows extracted content items that respectively correspond to soy source, ramen and shoes for husband included in the shopping list in FIG. 3.

The scheduling unit 323 adjusts schedules such that one or more advertising content items extracted by the tailored advertising content item extraction unit 322 are reproduced ahead of other advertising content items. In addition, if two or more advertising content items are extracted by the tailored advertising content item extraction unit 322, the scheduling unit 323 set is a reproduction order of the extracted advertising content items.

If any additional service, such as a coupon, is among the extracted advertising content items as shown in Table 1, the additional service generation unit 324 transfers the additional service to the mobile terminal 200.

The area-based content item generation unit 320b includes an area-based content search unit 326 and a tailored area-based content item extraction unit 327.

If the user memo data acquisition unit 310 receives from the user memo data acquisition unit 310 user memo data including a shopping list of a specific mobile terminal, the area-based content item search unit 326 searches for one or more content items related to an area where the specific mobile terminal is located. For example, if a mobile terminal 200 is located at a retail store, an area-based content item may be a list of products in the retail store, and locations of the products in the retail store according to a category.

From among one or more area-based content items found by the area-based content item search unit 326, the tailored area-based content item extraction unit 327 extracts only a tailored advertising content item belonging to a product category in the shopping list. Examples of content items extracted in the above way are shown in the following Table 2.

TABLE 2

| Content | Product | Category | Category | |
|---|---|---|---|---|
| Item ID | Name | 1 | N | Location |
| aaaa | xx soy source | soy source | groceries | First floor, A section, |
| | | | | 3^{rd} row |
| aaab | yy ramen | ramen | | First floor, A section, |
| | | | | 3^{rd} row |
| aaac | ABC shoes | shoes | men's | Second floor, B |
| | | | shoes | section, 5^{th} row |

Table 2 shows extracted store layout information that shows locations where soy source, is ramen and men's shoes in the shopping list in FIG. 3 are placed in a store.

The tailored area-based content item extractor 327 is able to extract not only content items, for example, content items shown in Table 2, but also map information showing locations of the content items in the store. That is, in order to provide a tailored service, suitable for an area where a digital signage is installed, based on a shopping list of a user, the tailored area-based content item extractor 327 may extract products in the shopping list from product information of the area, and then provide discount information and map information including display stand locations.

For example, if visiting A retail store and B retail store with the same shopping list memo data, a user may be provided with different tailored content items according to products and advertising content items of each of A retail store and B retail store.

A tailored content item output control unit 330 controls a tailored content item generated by the tailored content generation unit 320 to be output to the digital signage terminal 200.

If any additional service regarding an extracted content item exists, the additional service output unit 340 transfers the additional service to the mobile terminal 200.

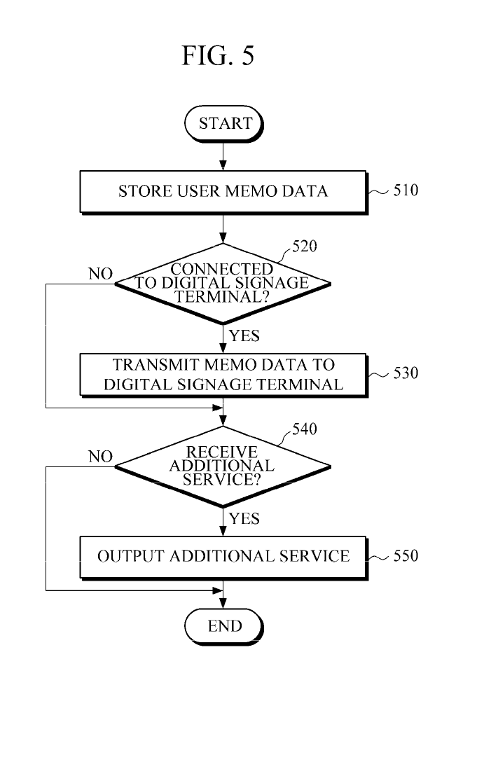

FIG. 5 is a flow chart illustrating operations of a mobile terminal according to an exemplary embodiment of the present invention.

Referring to FIG. 5, a mobile terminal 200 receives user memo data including a shopping list from a user and stores the received user memo data in 510. The user memo data is may be added or changed at any time, and an example of the user memo data is illustrated in FIG. 1.

If moving into an area where a specific signage terminal 100 is located, the mobile terminal 200 may be connected to a server 300 through the specific signage terminal 100 in 520.

Upon connection to the server 300, the mobile terminal 200 transfers the stored memo data to the server 300 through the digital signage terminal 100 in 530.

Then, whether the mobile terminal 200 receives an additional service from the server 300 is monitored in 540. The additional service received by the mobile terminal 200 may include a coupon.

If it is determined in 540 that the mobile terminal 200 receives an additional service from the server 300, the mobile terminal 200 outputs the additional service in 550. The additional service may be a coupon or area-based information.

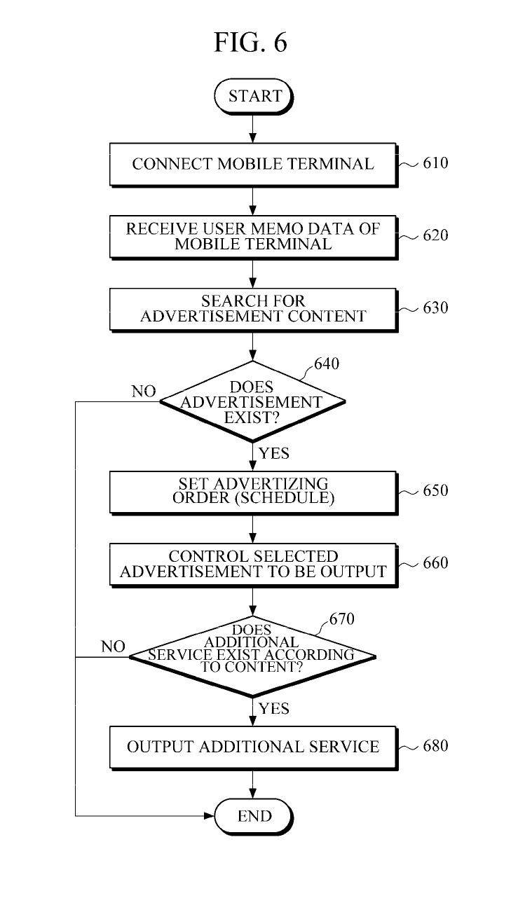

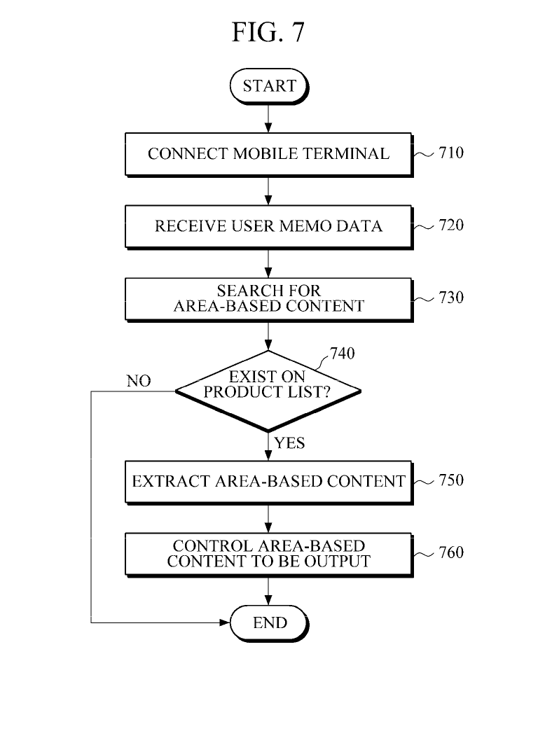

Hereinafter, a method whereby a digital signage service providing server provides a signage service reflecting a user's preference will be described. According to the present invention, two exemplary embodiments are possible. One embodiment describing a method for providing an advertising content item will be described with reference to FIG. 6, and the other embodiment describing a method for providing an area-based content item will be described with reference to FIG. 7.

FIG. 6 is a flow chart illustrating a method for providing a digital signage service reflecting a user's preference according to an exemplary embodiment of the present invention.

Referring to FIG. a mobile terminal 200 is connected to a server 300 through a specific signage terminal in 610, and the server 300 receives user memo data from the mobile terminal 200 based on ID of the mobile terminal 200 in 620. Hereinafter, a shopping list is cited as an is example of user memo data, but it is merely exemplary. That is, the user memo data may include various kinds of user preference information including a user's interest.

The server 300 generates an advertising content item corresponding to the user memo data in 630, 640 and 650. Specifically, in response to receipt of the user memo data including a shopping list of a specific mobile terminal, the server 300 searches for one or more advertising content items to be reproduced in a digital signage terminal 100 installed in an area where the specific mobile terminal is located.

The server 300 determines whether any advertising content item advertising products belonging to a category in the shopping list is among the found one or more advertising content items in 640.

If it is determined in 640 that there is an advertising content item advertising products belonging to a category in the shopping list, the server 300 set schedule such that the corresponding advertising content item, which advertises products belonging to a category in the shopping list, is output ahead of other advertising content items in 650. If it is determined that there is two or more advertising content items advertising products belonging to a category in the shopping list, the server 300 sets a reproduction order of the two or more advertising content items.

The server 300 transfers the found advertising content items and the schedule thereof to the digital signage terminal 100 so as to output a tailored advertising content item according to the schedule.

Additionally, the server 300 determines whether any additional service is among the found one or more advertising content items in 670.

If it is determined in 670 that an additional service exists, the server 300 transfers the additional service to the mobile terminal 200. The additional service may include a coupon.

FIG. 7 is a flow chart illustrating a method for providing a digital signage service reflecting a user's preference according to another exemplary embodiment of the present invention.

Referring to FIG. 7, a mobile terminal 200 is connected to a server 300 through a specific digital signage terminal in 710, and the server 300 receives from the mobile terminal 200 user memo data based on ID of the mobile terminal 200 in 720. Hereinafter, a shopping list is cited as an example of user memo data, but aspects of the present invention are not limited thereto. That is, the user memo data may include various kinds of user preference information including a user's interest.

In response to receipt of the user memo data including a shopping list of the mobile terminal 200, the server 300 generates a content item regarding to an area where the mobile terminal 200 is located in 730, 740 and 750. For example, if the mobile terminal 200 is located in a retail store, an area-based content item may be a list of products on sale in the retail store and locations of the products in the retail store.

Specifically, in response to receipt of the user memo data including a shopping list of the mobile terminal 200, the server 300 searches for one or more area-based content items, which are content items relating to an area where the mobile terminal 200 is located in 730.

The server 300 determines whether any area-based content items corresponding to a product belonging to a category in the shopping list are among the found one or more area-based content items in 740.

If it is determined in 740 that area-based content items corresponding to a product belonging to a category in the shopping list exist, the server 300 generates map information including a map that shows a location of a desired product in the retail store in 750. At this is time, additional information, such as a short cut for shopping, may be processed and provided according to the user's interaction.

The server 300 transfers the generated map information to a digital signage terminal 100 to be output in 760.

Additionally, the server 300, upon receipt of a shopping list of a user, may process information about an area where a digital signage terminal is installed, and the processed information about the area may be provided to a mobile terminal.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method whereby a digital signage service providing server provides a digital signage service reflecting a user's preference, the method comprising:
receiving user memo data from a mobile terminal through a specific digital signage terminal;
generating a tailored content item corresponding to a shopping list contained in the user memo data; and
outputting the generated tailored content item to the digital signage terminal.

2. The method of claim 1, wherein the generating of the tailored content item comprises
searching for one or more advertising content items to be reproduced in the digital signage terminal;
extracting, from among the found one or more advertising content items, an advertising content item corresponding to the shopping list; and
scheduling the extracted advertising content item to be output ahead of other advertising content items.

3. The method of claim 2, wherein, in the event that two or more advertising content item is extracted, the scheduling of the extracted advertising content item comprises setting a reproduction order of the two or more advertising content items.

4. The method of claim 2, further comprising:
in response to existence of an additional service regarding the one or more found advertising content items, transferring the additional service to the mobile terminal.

5. The method of claim 4, wherein the additional service may be a coupon related to the found advertising content items.

6. The method of claim 1, wherein the generating of the tailored content item comprises generating an area-based tailored content item based on the shopping list and information about an area where the digital signage terminal is installed.

7. The method of claim 6, wherein the generating of the tailored content item further comprises
determining whether a product included in the shopping list exists on a list of products in the retail store; and
in response to a determination that the product included in the shopping list exists on the list of products in the retail store, generating an area-based tailored content item containing a location of a desired product in the retail store.

8. The method of claim 7, wherein the area-based tailored content item comprises shortcut information for shopping according to a user's interaction.

9. A digital signage service providing server comprising:
a user memo data acquisition unit configured to receive user memo data from a mobile terminal through a specific digital signage terminal;
a content generation unit configured to generate a tailored content item corresponding to a shopping list contained in the user memo data; and
a tailored content item output control unit configured to output the generated tailored content item to the digital signage terminal.

10. The digital signage service providing server of claim 9, wherein the tailored content item generation unit comprises
an advertisement search unit configured to search for one or more advertising content items to be reproduced in the digital signage terminal;
a content item extraction unit configured to extract from among the one or more found advertising content items an advertising content item corresponding to the shopping list; and
a scheduling unit configured to schedule the extracted advertising content item to be output ahead of other advertising content items.

11. The digital signage service providing server of claim 10, wherein if two or more advertising content items corresponding to the shopping list are extracted, the scheduling unit sets a reproduction order of the two or more extracted advertising content items.

12. The digital signage service providing server of claim 10, wherein the content generation unit determines whether a product in the shopping list exists on a list of products in a retail store, and, in response to a determination that the product in the shopping list exists on the list of products in a retail store, generate an area-based tailored content item comprising a product that a user wishes to purchase.

13. A mobile terminal comprising:
a user memo data input interface unit configured to receive user memo data containing a shopping list from a user and store the received user memo data; and
a user memo data transfer unit configured to, in response to connection to a specific digital signage terminal, transfer the stored user memo data to the digital signage terminal.

14. The mobile terminal of claim 13, further comprising:
a digital signage providing unit configured to, in response to receipt of an additional service from the digital signage terminal, output the additional service.

15. A method whereby a mobile terminal able to be connected to a digital signage terminal provides a digital signage service reflecting a user's preference; the method comprising:
receiving user memo data from a user;
storing the received user memo data; and
in response to connection to a digital signage terminal, transferring to the stored user memo data to the digital signage terminal.

16. The method of claim 15, further comprising:
in response to receipt of an additional service from the digital signage terminal, outputting the additional service.
